(19) United States
(12) Patent Application Publication
(10) Pub. No.: US 2023/0130280 A1
(43) Pub. Date: Apr. 27, 2023

(54) Pre-Seeded Zinc Anodes for Secondary Batteries

(71) Applicant: City University of Hong Kong, Hong Kong (HK)

(72) Inventors: Chunyi ZHI, Hong Kong (HK); Qing LI, Hong Kong (HK)

(21) Appl. No.: 17/509,089

(22) Filed: Oct. 25, 2021

(51) Int. Cl. H01M 4/24; H01M 4/04; C25D 3/22

(52) U.S. Cl. CPC H01M 4/244; H01M 4/0438; C25D 3/22; H01M 2004/021

(57) ABSTRACT

The present invention provides a zinc battery anode that includes a first layer of zinc foil. An electroplated zinc seed layer is formed on the first layer of zinc foil, the electroplated zinc seed layer having a thickness in a range of 0.01 to 2 microns. The invention further provides a method for forming a seed layer on a zinc battery anode. In the process, the zinc seed layer is deposited on a zinc foil battery anode by electrochemical deposition from a zinc ion-containing solution at a current density of approximately 20 mA cm⁻² to 100 mA cm⁻² to form a uniform and dense seed layer. Through use of a seed layer on the zinc anode, dendrite formation is prevented and long battery life is demonstrated.

### FIELD OF THE INVENTION

The present invention relates to zinc anodes for secondary batteries and, more particularly, to pre-seeded zinc anodes that exhibit long-term stability and suppress dendrite evolution.

### BACKGROUND

The growing need for energy drives the development of various energy storage technologies beyond lithium-ion batteries (LIBs), and aqueous rechargeable Zn-based batteries (RZBs) are deemed as one of the most promising candidates for the next generation of large-format energy storage technology and wearable electronics as they are cost efficient, intrinsically safe, have low toxicity, and acceptable energy density. A zinc metal anode (ZMA) is still the most ideal anode to date, offering a high theoretical capacity of 812 mAh g⁻¹ and competitive electrochemical potential of −0.76 V; however, zinc anodes possess the serious shortcoming of a shortened lifespan due to dendrite formation. Efforts have been focused on eliminating dendrite formation through electrode design, interface modification, and electrolyte optimization. During battery operation, zinc ions plate onto the zinc anode surface during the charging process (plating) and are stripped during the discharge process (stripping). Research efforts have concentrated almost exclusively on the plating process, while understanding of stripping process of zinc metal anodes is poorly understood.

To study the plating/stripping behavior, the most representative model is the symmetric cell, supplying a representative platform to scrutinize the electrochemical behavior on the zinc surface by decoupling the cathode side. As such, the symmetric cell has been extensively applied in the related research of zinc metal anodes. The current analysis normally focuses on the survival time before shorting and the overall hysteresis in the voltage profile. However, the voltage profile is not perfectly flat, which points to the non-ideal stripping and plating process while the shape and variation of the voltage indicates more detailed information. However, a complete understanding of the voltage profile for the Zn—Zn system has not been achieved to date.

Further, the uneven plating and stripping as well as side effects during battery operation render the zinc metal anode irreversible, implying that the symmetric cell will be asymmetric in actual operation. Two electrodes involved in the same symmetric cell with the initial stripped zinc electrode (S-Zn) or initial plated Zn electrode (P-Zn) can reveal different electrochemical behaviors. Recent work on zinc metal anode optimization mainly focused on the plating process and morphology; however, the stripping behavior should be equally important. In particular, unlike typical lithium ion battery cathode materials having an initially discharged state, the typical cathodes of rechargeable zinc batteries (e.g., MnO₂, V₂O₅) are naturally in a charged state. That is, for rechargeable zinc batteries, the zinc metal anode will first encounter a stripping process when the battery is used, in contrast to lithium ion batteries. The understanding of the stripping process is even more essential in practice to construct a robust zin metal anode has been long neglected in the previous research of zinc metal anodes.

FIG. 1a depicts a flat Zn foil that is initially plated. The non-uniform nucleation in the initial cycles results in accumulating zinc dendrites in the following repeated cycles. However, in practical use, the situation is the opposite. The initial process in rechargeable zinc batteries is stripping instead of plating and pits will first form on the Zn surface (FIG. 1B). The difference between FIGS. 1a and 1b exemplifies the asymmetric behavior for plating zinc (P-Zn) and stripping zinc (S-Zn), demonstrating the importance of investigating the stripping behavior of zinc metal anodes.

Thus, there is a need in the art for improved zinc anodes that can withstand repeated cycles of stripping and plating without substantial dendrite formation. Such electrodes could be used in improved rechargeable zinc batteries.

### SUMMARY OF THE INVENTION

The present invention was obtained from a thorough investigation of both the stripping and plating behavior of zinc metal anodes. In particular, the time-voltage profiles of the two individual electrodes (P-Zn and S-Zn) of a symmetric cell were decoupled and monitored separately. The morphology evolution is further linked to the voltage response, providing insights into the voltage-time curves. As a result, a totally different morphology and performance evolution of P-Zn and S-Zn has been demonstrated. Dendrites grow in pit positions for stripping zinc, while dendrites grow on the surface and tips for plating zinc. The dendrites formed in the pits (stripping) are much more problematic than those that grow on the surface (plating). Through this observation, the “pre-seeding” structure of the present invention was developed to alleviate the dendrite formation. Through the pre-seeding treatment of the zinc metal anode surface, a uniform stripping/plating cycle was established in subsequent cycles for the pre-seeded Zn anode (PS-Zn) due to the epitaxial growth of the initially deposited layer. Consequently, a much-prolonged zinc anode lifespan has been demonstrated. The present invention is both simple and low cost for practical application to rechargeable zinc batteries.

In one embodiment, the invention provides a zinc battery anode that includes a first layer of zinc foil. An electroplated zinc seed layer is formed on the first layer of zinc foil, the electroplated zinc seed layer having a thickness in a range of 0.1 to 2 microns.

In a further embodiment, the invention provides a method for forming a seed layer on a zinc battery anode. In the process, the zinc seed layer is deposited on a zinc foil battery anode by electrochemical deposition from a zinc ion-containing solution at a current density of approximately 20 mA cm⁻² to 100 mA cm⁻² to form a uniform and dense seed layer.

### BRIEF DESCRIPTION OF THE DRAWINGS

FIGS. 1a and 1b are schematics drawings illustrating the stripping and plating of zinc: FIG. 1a P-Zn and FIG. 1b S-Zn.

FIG. 2ai-2aii and FIG. 2a1-2a6 depicts the polarization and morphology evolution of stripping zinc (S-Zn). FIG. 2a shows the potential evolution of S-Zn during the initial 3 cycles (i) and two selected cycles of later cycles (ii). FIGS. 2-a1-2-a6 show the corresponding morphology change of the status marked in the potential profiles of FIG. 2a under optical microscope and its schematic figures. The scale bar underneath is applicable for all the optical images of FIG. 2a1-2a6.

FIG. 3ai-aii and a1-a5 show the polarization and morphology evolution of plated zinc (P-Zn). FIG. 3a shows the potential evolution of P-Zn for the initial 3 cycles (FIG. 3ai) and two selected cycles of later cycles (FIG. 3aii). (a1-a5) the corresponding morphology change of the status marked in the potential profiles in 3a1-3a5 under optical microscope and its schematic figures. The scale bar underneath is applicable for the optical images of (3a1-3a5).

FIGS. 4a-4i show the morphology evolution investigation for two separate electrodes with different initial operation in a symmetric cell. FIG. 4a is an SEM images of the electrode being initially stripped, FIG. 4b is following the first plating, FIG. 4c is following the second stripping, FIG. 4d is after the third plating; FIG. 4e is the SEM image of the electrode being initially plated, FIG. 4f is following the first stripping, FIG. 4g is following the second plating, FIG. 4h is following the third stripping; FIG. 4i is an image of the disassembled zinc anode with different cycles of plating and stripping.

FIG. 5a-5h shows a pre-seeding investigation and electrochemical performance are based on half cells. FIG. 5a shows the voltage curves of zinc deposition at various current densities (mA cm⁻²); FIG. 5b shows the statistical data of voltage hysteresis and nuclei overpotential; FIG. 5c shows the SEM images of pre-seeded Zn at 50 mA cm⁻²; FIG. 5d shows the voltage-time profiles of bare Zn//Zn and P-Zn//P-Zn symmetric cells at current densities of 5 mA cm⁻², FIG. 5g shows the same for 7.5 mA cm⁻² while FIG. 5h shows the same for and 10 mA cm⁻² (h); FIG. 5e shows the zinc morphology of bare Zn compared to FIG. 5f P-Zn after cycling at 5 mA cm⁻².

FIGS. 6a-6h show the electrochemical performance of a full cell based on PS-Zn and bare Zn. FIG. 6a is the EIS spectra and FIG. 6b is the CV curve of the initial PS-Zn//MnO₂ and bare Zn//MnO₂ cell; FIG. 6c is the GCD profiles and FIG. 6d is the cycling performance at a current density of 0.5 A g⁻¹ with low loading mass; FIG. 6e is an SEM images of the disassembled bare Zn and FIG. f is the SEM image of the disassembled PS-Zn after plural cycles; FIG. 6g shows the cycling performance of PS-Zn//MnO₂ under a current density of 1 A g⁻¹ with high loading mass; FIG. 6h shows the long-term cycling performance of PS-Zn//C and bare Zn//C cell.

FIG. 7 schematically depicts a zinc anode with a pre-seeding layer on the anode surface.

FIG. 8a-8c shows the voltage-time profile of a symmetric cell combining two Zn foil electrodes; the voltage profile during charge and discharge is highly symmetric even though the voltage shape encounters some changes with the increase of time.

FIG. 9 is schematic representation of a voltage monitoring apparatus for two electrodes in a symmetric cell.

FIG. 10 is photograph showing dead zinc at the bottom of a cell.

FIG. 11a-11c shows the time-voltage profile for S-Zn power electrode (11a) and P-Zn power electrode (11b), and the full cell (11c).

FIG. 12 schematically depicts the distinct morphology evolution from pristine Zn to cycled S-Zn and P-Zn.

FIG. 13a-13f shows SEM images of Zn morphology deposited in different current density 1 (13a), 2 (13b), 5(13c), 10 (13d), 20 (13e), 50 (13f) mA cm⁻².

FIG. 14a-14b show deposited Zn with different current densities: (a) the digital images (a) and XRD curves of Zn with the increasing of Zn on a Cu current collector.

FIG. 15 is an SEM images of pre-seeded Zn with a current density of 20 mA cm⁻². The Zn deposited under 20 mA cm⁻² is uniform nucleated on the Zn surface.

FIG. 16 schematically depicts the uniform deposition of Zn due to the pre-seeded Zn layer.

FIG. 17 is the voltage-time profile of bare Zn//Zn and P-Zn//P-Zn symmetric cells at current densities of 10 mA cm⁻²

FIG. 18 is the EIS spectra of bare Zn//Zn and P-Zn//P-Zn symmetric cell.

FIG. 19 is the detailed voltage-time profile for P-Zn//P-Zn cell at the later stage of cycling with a current density of 2 mA cm⁻².

FIG. 20 is an SEM image of the δ-MnO₂ cathode.

FIG. 21 is the 3642^{nd} GCD curve of bare Zn//C after cycling.

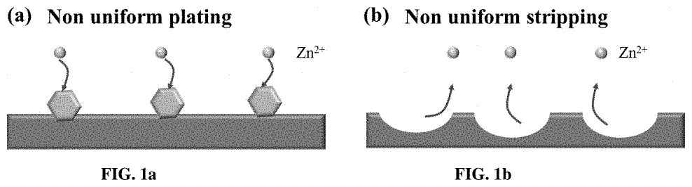

### DETAILED DESCRIPTION

This invention presents a pre-seeded zinc foil anode which includes a commercial zinc foil and the corresponding electrolytically-plated pre-seeding zinc layer. This pre-seeding Zn (PS-Zn) anode can serve as a dendrite free Zn anode that is both simple and low-cost and thus amendable to production for commercial-grade batteries.

FIG. 7 depicts a rechargeable battery anode 100. Anode 100 includes a base zinc layer 20. Base zinc layer 20 may be a commercially-available zinc foil having a thickness of approximately 20-100 microns. A pre-seeding layer 10 is electrolytically deposited on the base zinc layer 20. The pre-seeding layer is preferably a layer of dense, approximately hexagonal-shaped grains that are formed from initial seeds that spread and coalesce across the base zinc layer 20. As will be discussed in further detail below in the examples, the electroplating conditions affect the morphology of the pre-seeding layer 10 such that particular conditions produce a favorable pre-seeding layer morphology for suppressing dendrite formation. The thickness may range from 0.1 to 5 microns, or from 0.1 to 2 microns.

An electroplating solution may include a source of zinc ions such as ZnSO₄, Zn(AC)₂, or ZnCl₂. Further, surfactants and solvents may be selected to control the desired zinc seed layer morphology. Examples of such surfactants and solvents include one or more of polyvinyl pyrrolidone, sodium dodecyl sulfate, dimethyl sulfoxide, tetrahydrofuran.

The pre-seeded zinc anode 100 demonstrates much improved electrochemical performance: (i) the pre-seeded zinc symmetric cells cycled for more than 1000 h at 2 mA cm⁻² and 5 mA cm⁻²; (ii) the pre-seeded zinc symmetric cell also cycled for more than 500 h at 7.5 mA cm⁻² and 10 mA cm⁻²; (iii) no short circuit is observed within the 2000 cycles for the pre-seeded zinc //MnO₂ cell; (iv) the pre-seeded zinc//C cell demonstrates an ultralong life span above 10,000 cycles without any sign of short circuiting. Therefore, the pre-seeded zinc anode 100 is a promising commercial anode for Zn based battery applications.

The morphology evolution is further linked to the voltage response, providing insights into the voltage-time curves. As a result, a totally different morphology and performance evolution of P-Zn and S-Zn has been shown. Dendrites grow in pit positions for stripping zinc, while dendrites grow on the surface and tips for plating zinc. The dendrites formed in the pits (stripping) are much more problematic than those that grow on the surface (plating). For example, zinc dendrites grown from concave pits are above 200 μm in width after the third plating for an initially stripped zinc electrode (S-Zn), while they are less than 10 μm for an initially plated zinc electrode (P-Zn). Through the pre-seeding treatment of the zinc metal anode surface of the present invention, a uniform stripping/plating cycle was established in subsequent cycles for the pre-seeded Zn anode (PS-Zn) due to the epitaxial growth of the initially deposited layer. The epitaxial growth is originated from the lattice match of the former deposited dense Zn, and the deposited Zn is prone to follow the route of crystal growth. Consequently, a much-prolonged zinc anode lifespan has been demonstrated. The present invention is both simple and low cost for practical application to rechargeable zinc batteries.

### EXAMPLES

Experimental details:

Fabrication of P-Zn: At the beginning, the symmetric cell with two Zn foils (size: 1 cm×1 cm) was assembled with glass fiber (Whatman) as the separator and 2M ZnSO₄ as the electrolyte. One side was coated with 0.3 mAh cm⁻² Zn under the current density of 50 mA cm⁻².

Characterizations: Scanning electron microscopy (SEM, FEI Quanta 450 FEG SEM) was applied hereby to observe the Zn morphology. Bruker D2 Phaser with Cu Kα radiation (λ=0.15418 nm) operating at 30 kV and 10 Ma was adopted to obtain XRD curves. The optical microscope (Olympus, SC180) was cooperated with in-situ cells to observe the Zinc morphology during the plating process.

Cell assembly: Symmetric cells (coin cell 2032) were assembled by applying two pieces of P-Zn or bare Zn with 2M ZnSO4 as the electrolyte, Whatman glass fiber as the separator. Full cell applied P-Zn or bare Zn as the anode, MnO₂, or carbon as the cathode. The cathode slurry was composed of the δ-MnO₂ or active carbon, polyvinylidene fluoride (PVDF), carbon black with a ratio of 7:1:2. The slurry was cast into carbon cloth and dried at 80° C. overnight before use. The electrolyte for Zn//MnO₂ contains extra 0.1 MnSO₄ as the addictive to prevent MnO₂ dissolution.

Electrochemical measurements: EIS spectra were recorded by an electrochemical workstation (CHI 760E) within the frequency range of 100 KHz to 001 Hz. CV curves were conducted with the same CHI 760E workstation. Cycling performance and rate performance of both asymmetric and full cell were validated with a LAND test system. Voltage profiles for the separate electrode in the symmetric cell were recorded with two LAND channels at the same time.

Cell Polarization

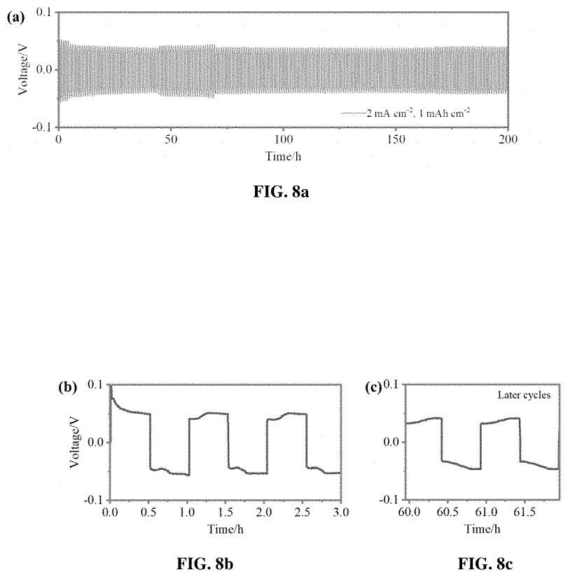

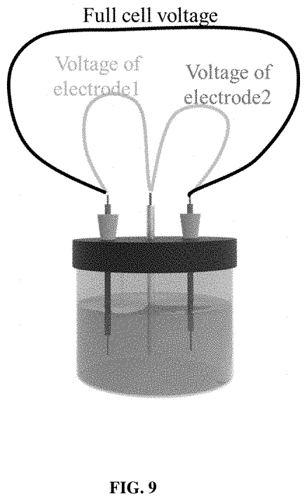

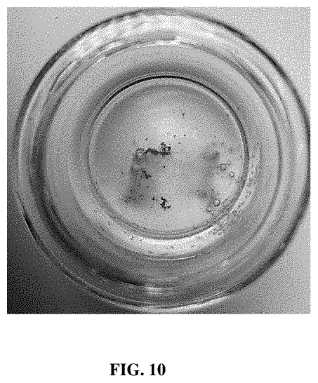

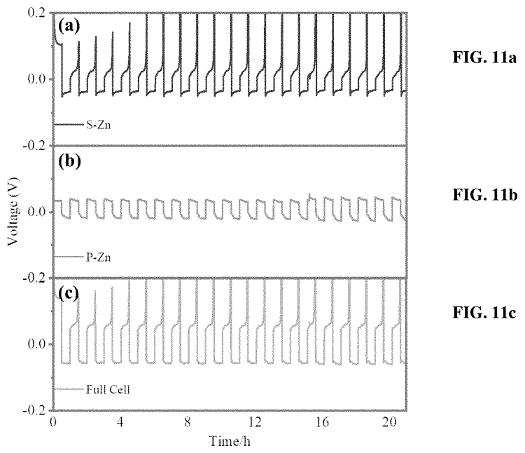

A typical voltage profile of a Zn//Zn symmetric cell is delineated in FIGS. 8a-c. The voltage profile during charge and discharge is highly symmetric even though the voltage shape encounters some change as the cycles progress. This configuration can be misleading since it gives rise to an interpretation that there is identical behavior of two electrodes. To further distinguish from the behavior of each electrode, the three-electrode configuration illustrated in FIG. 9 is applied, in which the working electrode and the counter electrode include two zinc foils, and the reference electrode is also a zinc foil. The separate voltage profiles of the working electrode and counter electrode were monitored by two LAND channels, and the overall voltage between the working electrode and counter electrode was also recorded via another channel. The process is also monitored by an in-situ optical microscope to comprehend the relevance between the voltage profile and the surface morphology evolution.

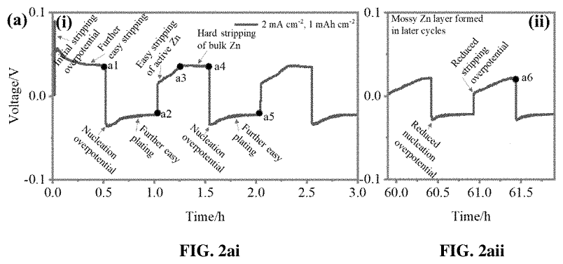

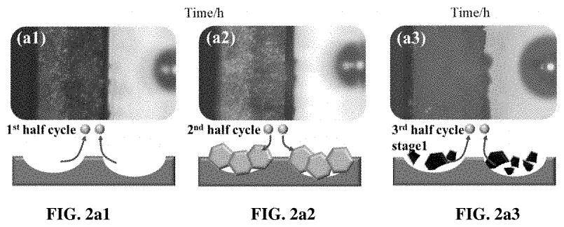

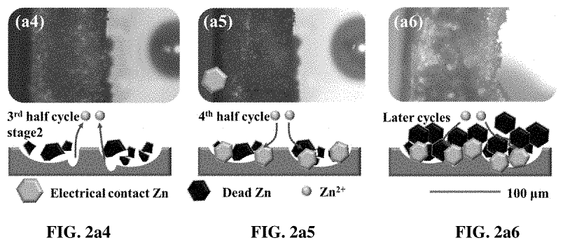

The results in FIG. 2a explicates the voltage evolution of the stripping zinc (S-Zn), demonstrating the types of voltage fluctuation during the stripping and plating process. In the very beginning, the abrupt voltage rise to around 0.1 V corresponds to the resistance of the initial stripping from the fresh zinc foil. At the end of the initial striping (FIG. 2a-i-a1 position), obvious pits or cracks can be observed, implying that the zinc extraction is not ideally uniform from the whole surface of zinc foil (FIG. 2a1). Instead, zinc is prone to strip from the positions which have already been activated by initial extraction and thus form the pits and cracks. The plating voltage of the first plating process is gradually increased with time, indicating that the beginning of the plating required a higher overpotential activation, and the following zinc plating on the basis of the former deposited zinc is relatively easily implied by the decreased voltage value. The morphology of Zn shown in FIG. 2-a2 in the 2^{nd} half cycle indicated that the pit is filled with deposited zinc as small protrusions appear, implying that the zinc prefers to deposit in the pit area and thus grows into small dendrites. In the subsequent stripping process, the initial stripping voltage is rather small, about 0.02 V, and then it is increased to 0.04 V (FIG. 2a-i-a3 position) in the middle, remaining at this level until the end of the stripping (FIG. 2a-i-a4 position). The voltage fluctuation in the second stripping process can be divided into two parts: the rising voltage and the stable voltage. The initial low voltage is attributed to the pre-existing mossy zinc deposited in the former process which is easy to strip. As the active zinc is removed from the mossy dendrites, it leads to a gradual voltage rise until the active zinc has run out.

The following stripping process is then switched to the bulk zinc (inactive zinc) which maintains a similar level of voltage. In this process, deeper pits are formed at the position of FIG. 2a-i-a4 compared with FIG. 2a-i-a3, suggesting that this process of stripping and plating for a single electrode is not highly reversible and each cycle can consume some unutilized zinc in the bulk body.

As seen in FIG. 2a4, remaining protrusions exist on the surface of zinc foil (which may result from the partially dead Zn) and are hard to strip. In the following plating process, zinc prefers to deposit in the valley position with the active surface and the valley being filled to form more dendrites on the surface (FIG. 2a5). Several cycles later, the stripping voltage profile in FIG. 2a-ii shows a gradually increasing voltage rather than the initial shape and is lower in value compared with the initial cycles of stripping. The reason is due to the formation of a thick layer of mossy zinc during the constant stripping and plating; the extraction of zinc from this mossy and active layer is relatively easy and occurs at a lower stripping voltage. The voltage is climbing slowly with the deeper stripping. Some of the mossy Zn can break down and form “dead Zn”, which can be observed at the bottom of the electrolytic tank described in FIG. 10. The formation of the mossy Zn can contribute to the formation of dendrites and penetrate the separator and cause battery failure.

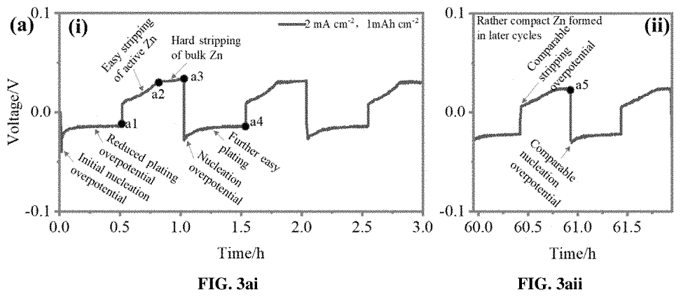

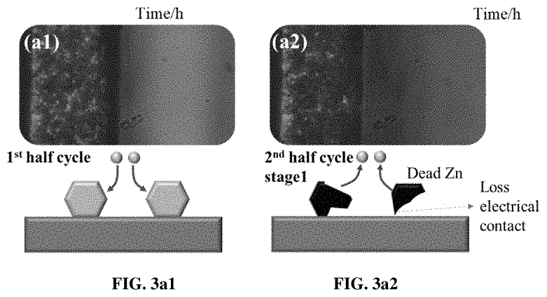

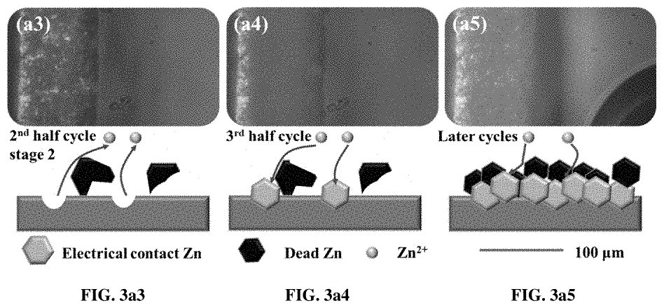

In case the plated zinc, as shown in FIG. 3ai, the voltage also encounters an increase to 0.04 V and soon goes back to stable around 0.02 V (FIG. 3ai-a1). This initial increase is attributed to the nucleation on the inactive zinc surface requires more energy, and then plating on the deposited zinc requires less energy with a lower voltage hysteresis. As compared with the voltage of ˜0.08 V needed to activate the stripping process (FIG. 2ai), the plating voltage is only half of the value, indicating that the stripping from the fresh zinc is more difficult than plating on the zinc surface. As seen in FIG. 3a1, the zinc is deposited onto the zinc surface and the deposited layer is observed. The stripping voltage profile (FIG. 3ai) exhibits a similar curve shape to that shown in FIG. 2ai with two stages: the voltage increasing stage (before FIG. 3ai-a2 position) and voltage maintaining stage (before FIG. 3ai-a3 position). The low stripping voltage in the beginning is attributed to the active zinc stripping and the voltage rises with the depletion of active zinc and then maintains the voltage level to extract the bulk zinc.

This process can be validated by the morphology evolution shown in FIGS. 3a2 and 3a3. The striping of zinc first consumes a part of the active zinc layer (FIG. 3a2) and then leads to a small concavity in the bulk and a small amount of dendritic zinc (FIG. 3a3), which is consistent with the stripping process shown in FIG. 2a4. In the subsequent plating process, the mossy zinc layer is deposited as shown in FIG. 3a4 with the decrease of the voltage (FIG. 3ai-a4 position). The voltage profile for this electrode after several cycles is similar to the stripping zinc but with a smaller plateau contribution, revealing the higher utilization of zinc and a lower ratio of extracting bulk zinc. At the same time, the deposited Zn is rather uniform and compact after several cycles as comparing to the stripping (FIG. 3a5 vs. FIG. 2a6), which is in accord with the comparable nucleation and stripping overpotential shown in FIG. 3aii.

Some similarities between the P-Zn and S-Zn are found: the shapes of stripping and plating process are alike. All stripping process show similar shapes with two stages: potential increasing stage and potential stable stage. This stripping process (FIG. 2ai, position 2a2-2a4, FIG. 2ai, position 2a1-2a3) is caused by deposited zinc in a previous cycle not being fully stripped in the later stripping process, leading to the extra consumption of bulk zinc. As a result, zinc in the stripping process can be divided into two parts: the previously-deposited zinc and bulk zinc. These two types of zinc demonstrate different kinetics: the dissolution is kinetically easy for the mossy, previously-deposited zinc, resulting in the low stripping voltage in the initial half stripping process. In contrast, bulk zinc, which possesses slower kinetics, leads to the plateau with higher voltage activation in the latter half stripping process. The potential for the plating process is constantly decreasing for both P-Zn and S-Zn. This decreasing voltage results from the initial nucleation which requires a high potential. The kinetics for the consequent plating should be faster than the new nucleation. The different voltage responses of stripping and plating processes prove that stripping and plating are not highly reversible. The kinetic difference of different plating and stripping stages gives rise to such potential evolution.

The difference in morphology evolution of S-Zn and P-Zn further demonstrates the distinctness of the electrodes. In other words, the symmetric cell becomes asymmetric. To further evaluate the differences between two electrodes which are initially stripped or plated, two zinc powder electrodes are provided. Differing from the zinc foil anode, zinc powder with a lower amount of zinc loaded is conducive to determining the diverse electrochemical behaviors of different electrodes. It can be observed from FIG. 11 that the voltage of a S-Zn powder electrode gradually increases for the subsequent stripping process. In contrast, the P-Zn powder electrode shows a stable voltage during 20 hours of cycling. These observations imply that the S-Zn shows a worse reversibility compared with the P-Zn. This confirms the phenomena depicted in FIGS. 2 and 3. The voltage hysteresis of S-Zn is also much higher than that of the initially plated electrode, indicating that better and stable electrochemical performance can be obtained for P-Zn.

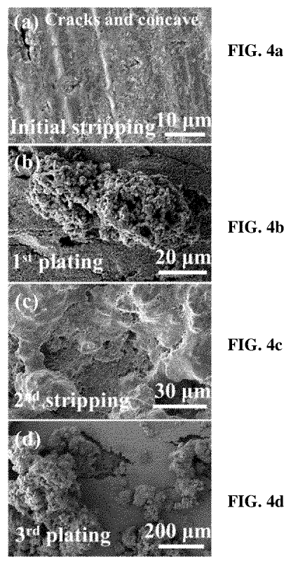

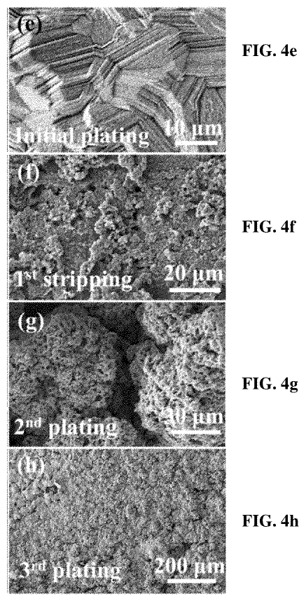

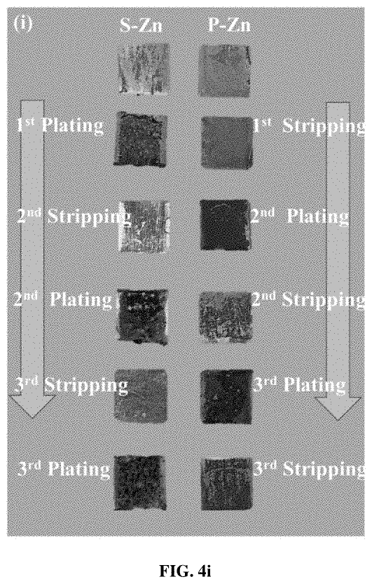

To ascertain the difference between S-Zn and P-Zn, scanning electron microscopy was performed for detailed surface morphology observation. Each zinc electrode experiences stripping and plating for 0.5 hrs with a high current density of 10 mA cm⁻² before the observation. FIG. 4a shows clear cracks and concaves on the S-Zn surface during the initial stripping, revealing a non-uniform stripping. The following plating on the same electrode illustrated in FIG. 4c implies that the zinc prior deposited in the position of the cracks which is kinetically favorable. The tree-like mossy Zn is planted in the concave and grows on the Zn surface which confirms the observation in FIG. 2. Further stripping takes the shape of a larger concavity than the initial stripping (FIG. 4c), validating the findings in the above discussion that each stripping process requires extra zinc from the bulk and forms the deeper concaves. The next plating demonstrates much more severe dendritic growth which is much larger in size with a width of more than 200 μm compared with that in the first plating with a width of 20 μm (FIG. 3d).

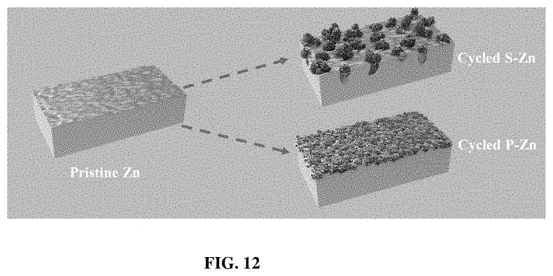

In contrast, the P-Zn demonstrates a distinct dendrite growth route, and the initial zinc plating layer is composed of the compact and dense flake structures (FIG. 4e). This layer disappears in the following stripping and small concavities form on the zinc surface (FIG. 4f). The subsequent plating shows the presence of mossy porous zinc growing from the bottom (FIG. 4g). For the third plating, the P-Zn is much more uniform and lower in terms of dendrite height (FIG. 4h) compared with the S-Zn (FIG. 4d). The digital images can also confirm the difference: the electrode with initial plating has a much more uniform deposit compared to the dendritic tree shape in the initially stripped electrode (FIG. 4i). The root cause of the distinction is the different active site caused by the initial stripping/plating. The distinct initial process leads to the different morphology evolution from pristine zinc: the initial stripping process for S-Zn leads to the formation of active sites in cracks and pits, thus leading to the tree-like morphology evolution during subsequent cycles. The initial plating for P-Zn gives rise to a relatively uniform plating behavior due to the generation of uniform active sites (FIG. 12).

Half-Cell Performance of PS-Zn

With the phenomenon observed in the previous example, the P-Zn exhibits a more uniform zinc morphology in the following cycles. However, rechargeable zinc batteries are initially in a charged state, as-formed. In the initial battery use, the zinc anode donates Zn²⁺ and the cathode receives Zn²⁺, corresponding to a stripping process at the zinc anode. Based on these analyses, an initial nuclei seed layer was determined to be an effective solution to dendrite growth problems.

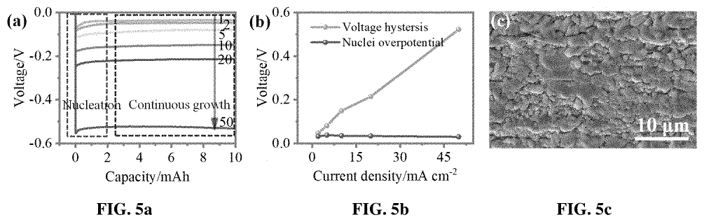

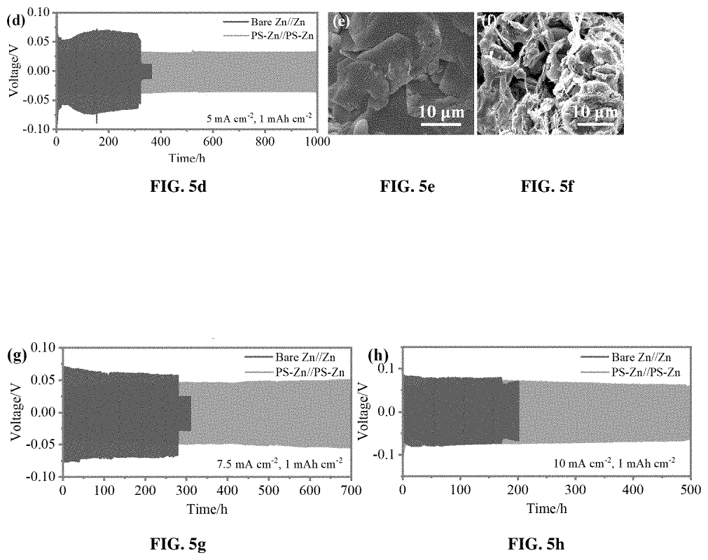

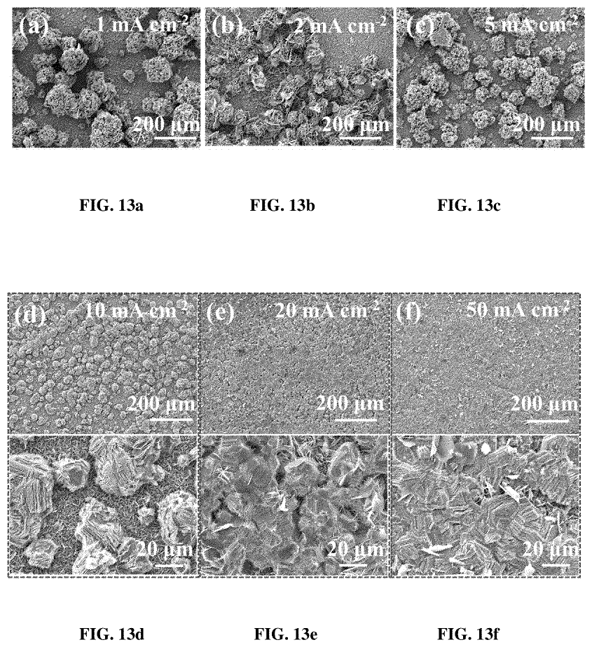

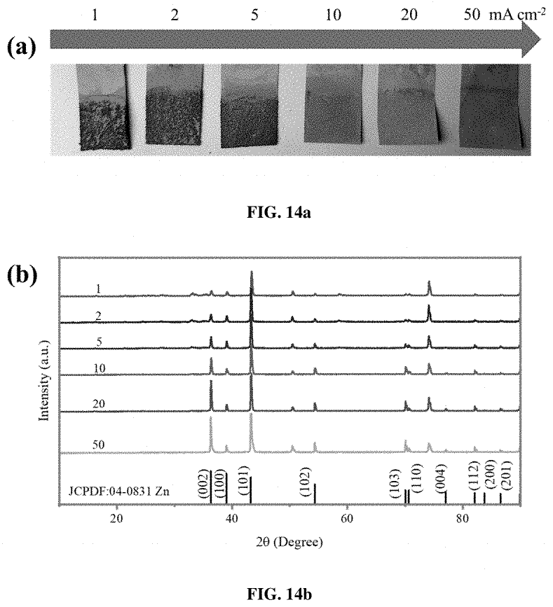

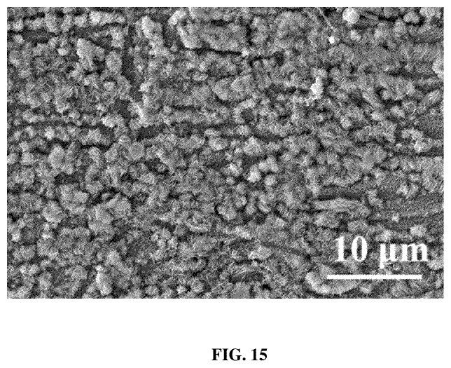

The deposition behavior was first surveyed. The deposition of zinc is composed of two parts as shown in FIG. 5a: nucleation and continuous growth. Both processes are strongly influenced by the current density. The morphology is examined by SEM observation. As shown in FIG. 13, the nucleation size decreases with an increase in current density and the nucleation density is proportional to the current density. The deposited zinc is concentrated on particles rather than uniform distribution in the area (FIG. 13a, 13b) at low current density. Zinc covers a large portion of a substrate of moderate size when current density is increased to 10 mA cm⁻² (FIG. 13d). Comparatively, the deposited zinc at 50 mA cm⁻² demonstrates the highest uniformity and almost all area is covered (FIG. 13f). In addition to the morphology, the crystallinity and crystallographic orientation are also highly associated with the current density. The deposited zinc demonstrates color changes from black with low current density to grey with higher current density with better distribution (FIG. 14a), reflecting the fact that the zinc deposited at a higher current density above 10 mA cm⁻² shows higher crystallinity and a more compact structure. The intensities of (002), (103) (FIG. 14b) are consolidated with the current density increasing with 0-30° alignment to the substrate which is less likely to form dendrites, and the initial crystallographic orientation will exert an impact on the zinc deposition in the consequent cycles. The static voltage hysteresis is proportional to the current density increasing while the nucleation overpotential clarifies the limited change (FIG. 5b). One possible assumption of the observed nuclei density change with the current density is explained by the voltage hysteresis. To create the desired morphology and crystallographic orientation, a higher current density above 20 mA cm⁻² is selected as the pre-deposition current to create the seed layer.

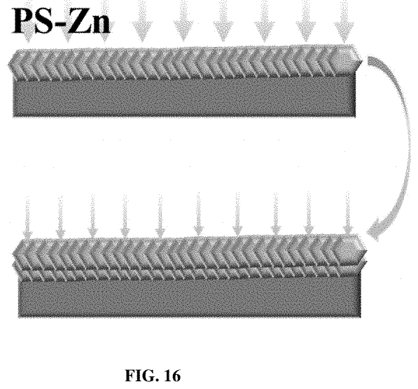

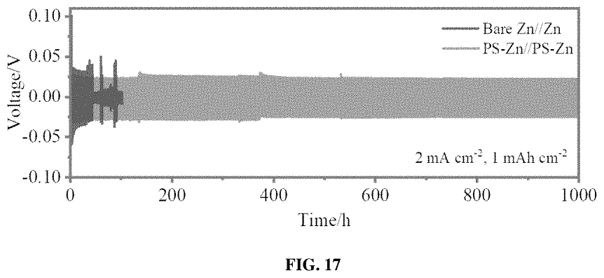

A small amount of zinc 0.3 mAh cm⁻² is chosen as seeds to observe the nucleation process on a zinc foil. 20 mA cm⁻² and 50 mA cm⁻² are compared to determine the effect of current density as investigated above. As shown in FIG. 15 the zinc deposited at 20 mA cm⁻² is uniformly nucleated on the zinc surface, but it is isolated from batch to batch. When the current density is increased to 50 mA cm⁻², the plated zinc uniformly covers the surface with a compact layer structure (FIG. 5c). This dense and compact pre-seeded zinc (PS-Zn) serves as the layer for subsequent uniform plating/stripping (FIG. 16).

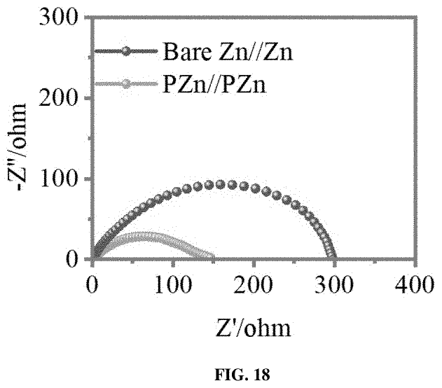

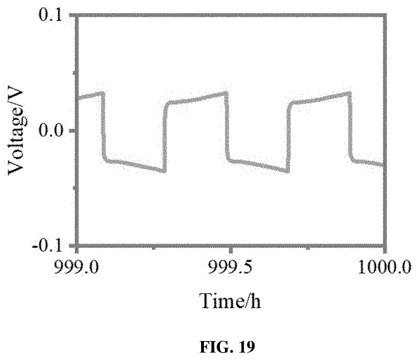

To further demonstrate the long-term cyclability, a symmetric cell is assembled. The untreated zinc symmetric cell at a current density of 2 mA cm⁻² undergoes only 50 hours of operation and the voltage hysteresis is about 70 mV (Figure S17). The PS-Zn//PS-Zn cell survived for over 1000 hours with a stable voltage profile and a lower voltage hysteresis of 52 mV, implying that PS-Zn is kinetically faster than the bare zinc and leads to a uniform stripping/plating. This can also be validated by the electrochemical impedance spectra (EIS) in FIG. 18, the R_{ct} demonstrates that PS-Zn//PS-Zn is about 150Ω which is half of the value for bare Zn//Zn cell (300Ω). Meanwhile, for the PS-Zn//PS-Zn cell, the voltage profile after 1000 hrs still shows a stable curve alike the initial cycles (FIG. 19). When the current density is increased to 5 mA cm⁻², the bare Zn//Zn cell results in a lifespan of over 300 hours before the voltage drop and battery shorting out (FIG. 5d) while the PS-Zn//PS-Zn exhibits a long lifespan of over 1000 hrs. The voltage hysteresis also declines by applying this pre-seeding strategy from 141 mV to only 70 mV, suggesting a highly stable stripping and plating. The cell after 1000 hours cycling is disassembled for further validation. As seen in FIG. 5e, the zinc deposition in the entire range is substantially uniform with blocks of hexagon platelets. In contrast, the untreated zinc after short circuiting shows a non-uniform distribution in the z-direction (FIG. 5f), leading to exaggerated dendrite growth with a higher possibility of piercing through a battery separator, finally resulting in a short circuit.

Further cycles under a higher current density of 7.5 mA cm⁻² (FIGS. 5g) and 10 mA cm⁻² (FIG. 5h) are conducted, showing that the PS-Zn//PS-Zn cells all have a longer life span and lower voltage hysteresis, confirming the high stability induced by PS-Zn. This pre-seeding strategy can greatly improve the stability of zinc foil without the synthesis of complex materials or use of intricate preparation methods, since the active and uniform pre-seeding promotes subsequent uniform deposition (FIG. 16).

Full Cell Evaluation of PS-Zn

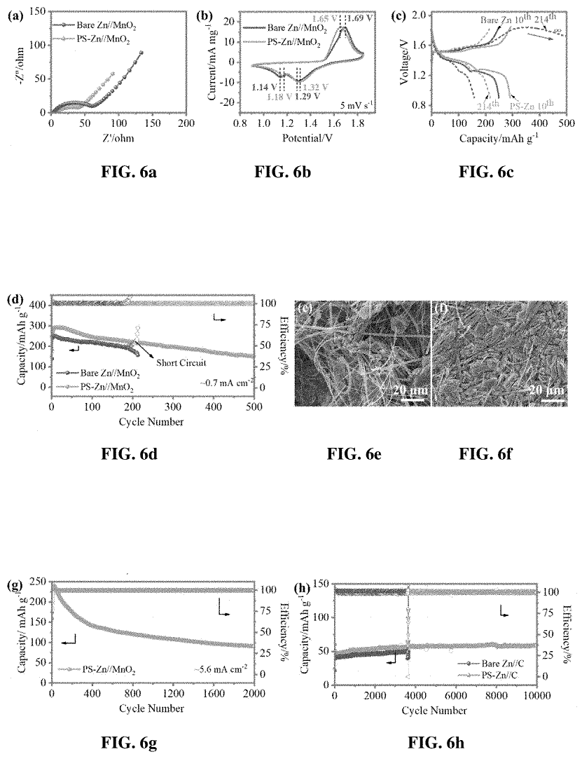

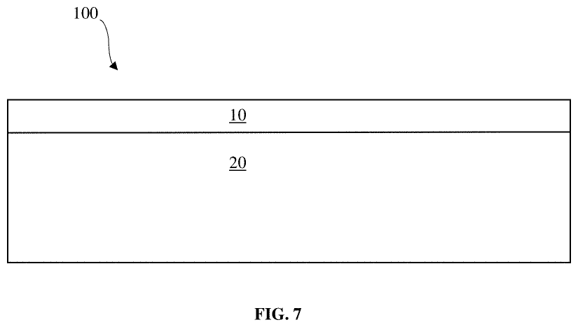

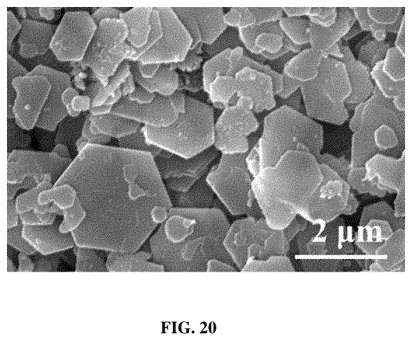

Ultimately, full cells of bare Zn and PS-Zn were constructed with δ-MnO₂ cathodes (FIG. 20) are assembled to evaluate the influence of the S-Zn and P-Zn anode on the full cell performance. The EIS spectra of the initial cells of bare Zn//MnO₂ and PS-Zn//MnO₂ proves that the R_{ct} of PS-Zn//MnO₂ cell with 40Ω is much less than that of bare Zn//MnO₂ cell with 65Ω shown in FIG. 6a, suggesting that the PS-Zn is kinetically faster. The cyclic voltammetry (CV) curves in FIG. 6b fit well with the EIS findings. The oxidative peak (1.65 V) of PS-Zn//MnO₂ is lower than that of bare Zn//MnO₂ (1.69 V), and the reductive peaks of PS-Zn//MnO₂ are all higher (1.32 V vs 1.29 V, 1.18 V vs 1.14 V) than that of bare Zn//MnO₂. The results suggest that there is less polarization of PS-Zn compared with the bare zinc. Further cycling performance shown in FIGS. 6c and 6d with a current density of 0.5 A g⁻¹ shows a slightly higher capacity for PS-Zn//MnO₂. After 200 cycles, the charge and discharge capacity of bare Zn//MnO₂ deviates gradually, and its columbic efficiency drops accordingly. The cell finally fails at the 214^{th} cycle shown in FIG. 6c. The charge curve of the dashed line corresponds to infinite capacity, and the voltage cannot reach out for the cut-off voltage (1.85 V) which is normally viewed as a short circuit. The failure of the cell can be ascribed to the dendrite formation of the zinc anode, in support of the prior conclusion for the symmetric cell that the S-Zn more readily forms dendrites.

In contrast, the PS-Zn//MnO₂ cell reveals a similar cycling trend without generating a short circuit (FIG. 6d). The galvanostatic charge-discharge (GCD) curves of PS-Zn//MnO₂ demonstrates higher discharge plateaus and a lower charge plateau which is consistent with the CV peaks (FIG. 6c). The cells are disassembled after cycling for further analysis. As shown in FIG. 6e, the morphology of bare zinc is unregulated with sharp tips and a recessed area demonstrates even deposition, and the zinc grows into the glass fibers leading to a further short circuit. In contrast, the PS-Zn exhibits a flat surface with uniform and compact zinc covering which can be traced back to the uniform active sites created in the initial plating process (FIG. 6f), resulting in the regulated growth during subsequent deposition. High mass loading of the cathode MnO₂ is applied to demonstrate the dendrite resistance of PS-Zn. That no short circuit is observed within 2000 cycles demonstrates that no dendrite piercing occurs at high current density and deposition amounts (FIG. 6g).

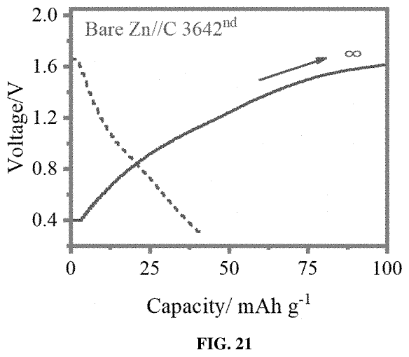

A Zn//C cell with an extremely stable carbon cathode is further assembled to evaluate the anode performance, and the results are illustrated in FIG. 6h. The PS-Zn//C cell demonstrates an ultralong life span above 10,000 cycles without any sign of short circuit. The bare Zn//C cell encountered capacity deviation and columbic efficiency drops similar to those of the MnO₂ cathode cell, and finally fails at the 3642^{nd} cycle. The GCD curve also demonstrates an infinite charge capacity and voltage remains below the cut-off voltage (FIG. 21). The full cells all corroborate the different behaviors between the initially stripped and initially plated zinc, suggesting the preliminary nucleation of zinc exerts a substantial impact on the consequent deposition.

While the present disclosure has been described and illustrated with reference to specific embodiments thereof, these descriptions and illustrations are not limiting. It should be understood by those skilled in the art that various changes may be made and equivalents may be substituted without departing from the true spirit and scope of the present disclosure as defined by the appended claims. The illustrations may not necessarily be drawn to scale. There may be distinctions between the artistic renditions in the present disclosure and the actual apparatus due to manufacturing processes and tolerances. There may be other embodiments of the present disclosure which are not specifically illustrated. The specification and the drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations.

1. A zinc battery anode comprising:
a first layer of zinc foil;
an electroplated additive-free zinc seed layer having a dense hexagonal crystalline morphology disposed on the first layer of zinc foil, the electroplated zinc seed layer having a thickness in a range of 0.01 to 2 microns.

2. (canceled)

3. The zinc battery anode of claim 1, further comprising a dense epitaxial layer of zinc deposited over the electroplated zinc seed layer.

4. A rechargeable zinc battery including the zinc battery anode of claim 1.

5. The rechargeable zinc battery of claim 4 including a cathode active material selected from MnO₂, active carbon, Prussian blue analogues, or V₂O₅.

6. A method of forming a zinc battery anode comprising:
providing a first layer of zinc foil;
electroplating an additive-free zinc seed layer having a dense hexagonal crystalline morphology on the first layer of zinc foil to a thickness of approximately 0.01 to 2 microns.

7. The method of claim 6, wherein the electroplating is from a zinc ion-containing solution, wherein the zinc is supplied from ZnSO₄, Zn(AC)₂, or ZnCl₂.

8. (canceled)

9. The method of claim 6, wherein the electroplating is performed from 0.1 mAh/cm² to 2 mAh/cm².

10. The method of claim 6, wherein the seed zinc is electroplated at a current density of at least approximately 20 mA cm⁻².
